(19) United States
(12) Patent Application Publication
(10) Pub. No.: US 2004/0195801 A1
(43) Pub. Date: Oct. 7, 2004

(54) Height-adjustable coupling assembly with load-bearing pin for use with a gooseneck trailer

(76) Inventor: Hector Lara, El Paso, TX (US)

Correspondence Address: WHYTE HIRSCHBOECK DUDEK S C, 555 EAST WELLS STREET, SUITE 1900, MILWAUKEE, WI, 53202, US

(21) Appl. No.: 10/631,270

(22) Filed: Jul. 31, 2003

Related U.S. Application Data
(63) Continuation-in-part of application No. 10/097,885, filed on Mar. 14, 2002.
(60) Provisional application No. 60/318,227, filed on Sep. 7, 2001.

(51) Int. Cl. B60D 1/00

(52) U.S. Cl. 280/490.1

(57) ABSTRACT

Disclosed herein is a coupling assembly for use with a gooseneck trailer. The coupling assembly comprises a height-adjustment device and a coupler mechanism. The coupling assembly further comprises a locking assembly and a pair of friction fit assemblies. The height-adjustment device within the coupling assembly uses a load-bearing pin to concurrently and/or simultaneously perform two functions, namely permitting adjustablility of the coupling assembly and bearing all, or substantially all, of a vertical load (i.e., withstanding a shear force) provided by an attached gooseneck trailer, any trailer accessories, and any trailer contents. Because the load-bearing pin bears all, or substantially all, of the vertical load by resisting the shear force, conventional reliance upon a friction force to bear the vertical load is substantially eliminated. A tongue on the gooseneck trailer connects the gooseneck trailer to the coupling assembly and the coupler mechanism on the coupling assembly secures a ball mount on a towing vehicle to the coupling assembly. As such, the gooseneck trailer and the towing vehicle can be coupled and uncoupled. The locking assembly on the coupling assembly alternatively locks and unlocks the coupler mechanism. The friction fit assemblies on the coupling assembly inhibit relative side-to-side movement between an inner and outer member within the coupling assembly.

### CROSS-REFERENCE TO RELATED APPLICATIONS

This application claims the benefit of the filing date of U.S. application Ser. No. 10/097,885, filed on Mar. 14, 2002, pending, which claims the benefit of U.S. provisional application Serial No. 60/318,227, filed on Sep. 7, 2001, expired.

### BACKGROUND OF THE INVENTION

1. Field of the Invention

The present invention generally relates to a coupling assembly for securing a trailer to a 10′ towing vehicle. In one aspect, the coupling assembly comprises a coupler mechanism and a height-adjustment device, the height-adjustment device utilizing apertured coupling members and a load-bearing pin, the load-bearing pin being selectively insertable within the apertures in the coupling members to permit height adjustment of the coupler and to accept a vertical load delivered to the coupling assembly by the trailer.

2. Description of the Related Art

A typical trailer, such as a gooseneck trailer, comprises a trailer mount assembly and an attached coupling assembly. The coupling assembly is configured to receive a ball mount secured to a bed of a towing vehicle. When the coupling assembly receives and secures the ball mount, the towing vehicle is “coupled” to the trailer. When coupled, the towing vehicle can transport the trailer. When no longer needed, the trailer can be “uncoupled” from the towing vehicle by releasing the coupling assembly. When released, the ball mount is unsecured and discharged from the within the coupling assembly. Thereafter, the towing vehicle can proceed unencumbered by the trailer. The process of coupling, and uncoupling, can be repeatedly performed.

Many conventional coupling assemblies include inner and outer tubular members associated with a variety of bolts, pins, and/or other connectors [hereinafter bolt]. The tubes are disposed in a telescopic mating, engagement. Therefore, the combined height of the tubes can be increased or decreased by sliding the tubes relative to each other. The bolt secured to the outer tube typically extends through an aperture in the outer tube and contacts the sliding surface of the inner tube. The bolt can thereafter generate friction at the inner tube to maintain the tubes at a desired, combined height. The friction supplied by the bolt permits the coupling assembly to bear a vertical load exerted by a trailer and its contents. Thus, conventional, adjustable coupling assemblies permit a trailer to be leveled and then secured for suitable towing using the force of friction generated by a bolt or like device. Unfortunately, the use of friction in a coupling assembly may permit slippage between the tubes if the force of friction should waver or be overcome.

In U.S. Pat. No. 6,234,509 (Lara), telescopic, outer and inner tubes are employed in a coupling assembly. As illustrated in FIG. 6, an adjusting nut is secured to the outer tube proximate an outer tube aperture. The adjusting nut receives a corresponding adjusting bolt that can advance or retreat within the adjusting nut and outer tube aperture when rotated. When the desired height of the combined inner and outer tubes is achieved, the adjusting bolt is rotated until a distal end of the adjusting bolt is biased against the inner tube. With the distal end of the adjusting bolt lodged against the inner tube, friction is created between the distal end of the adjusting bolt and the inner tube. The adjusting bolt maintains the desired height of the combined inner and outer tubes and bears a portion of the vertical load provided by a trailer attached to the coupling assembly. Friction, and friction alone, permits the adjusting bolt in the coupling assembly to perform these two functions.

In another embodiment of U.S. Pat. No. 6,234,509 (Lara), the use of a plunger pin assembly in combination with an adjusting bolt and nut is disclosed. As illustrated in FIGS. 4 and 5, the plunger pin assembly comprises a plunger pin (i.e., a non-threaded bolt) and a compression spring biasing the plunger pin. The plunger pin assembly is welded to the outer tube proximate an outer tube aperture. The inner tube contains a single column of inner tube apertures. When the outer tube aperture slidably aligns with one of the inner tube apertures, the plunger pin is released and inserted through the outer aperture as well as one of the inner tube apertures. Thereafter, the adjusting bolt is rotated until a distal end of the adjusting bolt is biased against the inner tube. The plunger pin, in combination with the adjusting bolt, maintains the desired height of the combined inner and outer tubes and bears the vertical load provided by the trailer attached to the coupling assembly. Therefore, friction and a shear withstanding force, in combination, allow the coupling assembly to provide height adjustment as well as bear the vertical load of the trailer and its contents. As such, friction is still being relied upon to assist in maintaining coupling assembly height.

While the above coupling assemblies very capably permit towing of a trailer, an improved coupling assembly would be desirable.

### SUMMARY OF THE INVENTION

In one aspect, the invention provides a coupling assembly for use with a trailer such as a gooseneck trailer. The coupling assembly comprises a height-adjustment device and a coupler mechanism.

The height-adjustment device includes an inner member, an outer member, and a load-bearing pin. The inner member has opposing inner member aperture pairs while the outer member has an opposing outer member aperture pair. The outer member telescopically, slidably receives the inner member such that the inner member can be height adjusted with respect to the outer member. The load-bearing pin is selectively insertable through one of the opposing inner member aperture pairs and the opposing outer aperture pair. In one embodiment, the inner member and the outer member can be elongate members that contain pairs of apertures that are circumferentially aligned.

The coupler mechanism is secured to the height-adjustment device and engageable to a mount secured to a towing vehicle. The load-bearing pin can bear substantially all of a vertical load exerted upon the coupling assembly. In one embodiment, the load-bearing pin can bear any vertical load exerted upon the coupling assembly.

The coupling assembly can include a friction fit assembly that is employed to maintain co-axial alignment of the inner member and the outer member. The friction fit assembly and the load-bearing pin can be longitudinally disposed along the outer member at approximately the same height. The friction fit assembly can include a fixed nut, a lock nut, and an adjustment bolt.

The coupling assembly can also contain a locking assembly to alternatively ensure securement and permit release of the mount within the coupler mechanism. The locking assembly can be assembled from a locking pin, a locking pin spring, a locking pin handle, and a locking pin cover.

A tongue on the trailer can connect the trailer to the coupling assembly. Further, the coupler mechanism on the coupling assembly can secure the mount on the towing vehicle to the coupling assembly.

In one embodiment, the load-bearing pin can be angled proximate one end and contain a load-bearing pin aperture proximate another end. A cotter pin can be securable within the load-bearing pin aperture to secure the load-bearing pin within the coupling assembly.

The inner member can define an inner member height and the outer member can define an outer member height. Therefore, when the inner member height and the outer member height are summed, a device height is defined. The device height can be adjusted to level the trailer with respect to a towing vehicle, the gooseneck trailer, or a combination of the towing vehicle and the gooseneck trailer.

In another aspect, the invention provides a system for adjusting coupling assembly height. The system comprises a coupling assembly, which contains a height-adjustment device and a coupler mechanism, and a gooseneck trailer, which contains a tongue connecting the gooseneck trailer to the coupling assembly. The system uses the height-adjustment device such that a load-bearing pin is securable within one of opposing inner member aperture pairs and a opposing outer member aperture pair to adjust the coupling assembly height. The load-bearing pin can also bear substantially all of a vertical load exerted upon the coupling assembly.

The system can further include the towing vehicle and the coupler mechanism. The coupler mechanism can be releasably engaged to the mount secured to the towing vehicle. The coupler mechanism can also alternatively permit coupling and uncoupling of the gooseneck trailer to and from the towing vehicle.

In yet another aspect, the invention provides a method of leveling a trailer. The method can comprise initially providing a coupler mechanism and a height adjustment device. The height adjustment device can include an inner member, which has opposing inner member aperture pairs and defines an inner member height, and an outer member, which has an opposing outer member aperture pair and defines an outer member height. The outer member telescopically, slidably receives the inner member. The height-adjustment device also includes a load-bearing pin that can be selectively insertable through one of the opposing inner member aperture pairs and the opposing outer member aperture pair.

The inner member and the outer member can be adjusted relative to each other such that a desired height is achieved and a channel is formed proximate the desired height. Thereafter, the load-bearing pin can be inserted within the channel formed by the adjusted members such that the load-bearing pin bears substantially all of a vertical load provided by the trailer while maintaining the desired height of the trailer. This can ensure that the trailer is leveled. The method can further comprise securably receiving a mount within the coupler mechanism where the mount is secured to a towing vehicle.

In one embodiment, the method can include providing a friction fit assembly for promoting co-axial alignment of the inner member and the outer member. Further, the method can also include providing a locking assembly for preventing undesirable disengagement of a mount securably received within the coupler mechanism. In one embodiment, the locking assembly includes a locking pin such that the locking pin can be manually manipulatable to alternatively couple and uncouple the mount and the coupler mechanism.

### BRIEF DESCRIPTION OF THE DRAWINGS

Embodiments of the invention are disclosed with reference to the accompanying drawings and are for illustrative purposes only. The invention is not limited in its application to the details of construction or the arrangement of the components illustrated in the drawings. The invention is capable of other embodiments or of being practiced or carried out in other various ways. Like reference numerals are used to indicate like components.

FIG. 1 illustrates a side, elevational view of a trailer employing an embodiment of a coupling assembly, according to one aspect of the invention, and secured to a towing vehicle.

FIG. 2 illustrates a side, elevational view of the coupling assembly of FIG. 1.

FIG. 3 illustrates a side, elevational view of the coupling assembly of FIG. 2 rotated ninety degrees about axis A.

FIG. 4 illustrates a top, cross-sectional view, taken along lines 4-4 of FIG. 2 of a height-adjustment device and a friction fit assembly.

FIG. 5 illustrates a side, cross-sectional view, taken along line 5-5 of FIG. 4, of the height-adjustment device.

FIG. 6 illustrates a top, plan view of the load-bearing pin and cotter pin used in the height-adjustment device of FIG. 5.

FIG. 7 illustrates a side, elevational view of a trailer employing the height-adjustment device of FIG. 5 (within the coupling assembly of FIG. 2) to control trailer pitch.

FIG. 8 illustrates a side, elevational view of a coupler mechanism within a lower portion of the coupling assembly of FIG. 2.

FIG. 9 illustrates a top, cross-sectional view, taken along line 9-9, of the lower portion of the coupling assembly of FIG. 8 with a lock plate shown in the open position.

FIG. 9A illustrates a top, cross-sectional view, taken along line 9-9, of the lower portion of the coupling assembly of FIG. 8 with the lock plate shown in the closed position.

FIG. 10 illustrates a perspective view of another embodiment of a height-adjustable coupling assembly.

FIG. 11 illustrates a top, cross-sectional view, taken along lines 11-11 of FIG. 10 showing another embodiment of a height-adjustment device having a plurality of friction fit assemblies.

### DETAILED DESCRIPTION OF THE PREFERRED EMBODIMENTS

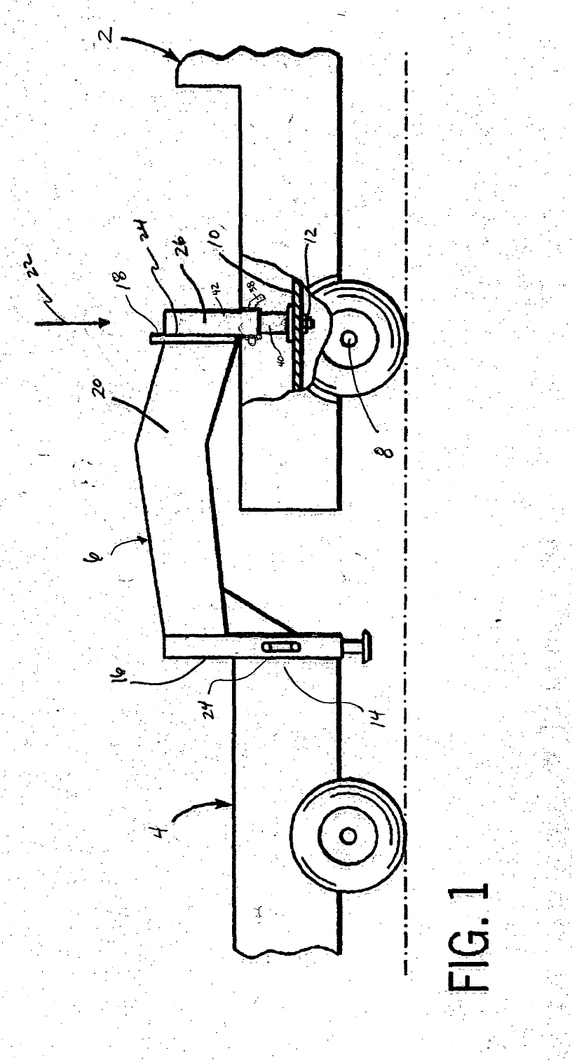

In FIG. 1, towing vehicle 2, trailer 4, and trailer mount assembly 6 are illustrated. Towing vehicle 2 comprises a rear axle 8 and a towing vehicle bed 10, the bed having bed aperture 12 disposed therein. Trailer 4 can comprise any conventional trailer for transporting cargo and the like and defines trailer end area 14. Trailer mount assembly 6 comprises first tongue end 16, second tongue end 18, and tongue 20 disposed between the first and second tongue ends. In the embodiment shown, tongue 20 comprises a gooseneck-shaped tongue and, therefore, trailer 4 is known as a gooseneck trailer. Tongue 20 can extend over towing vehicle bed 10 such that second tongue end 18 is vertically disposed above rear axle 8 of towing vehicle 2. Directional arrow 22 indicates the direction of a vertical load (and resultant shear force) created by trailer 4, any trailer accessories (e.g., tongue 20), and any trailer contents. Trailer 4 is secured to first tongue end 16 at trailer end area 14, typically by welds 24 or other conventional means. Also, second tongue end 18 is secured, typically by welds 24 or other conventional means, to coupling assembly 26.

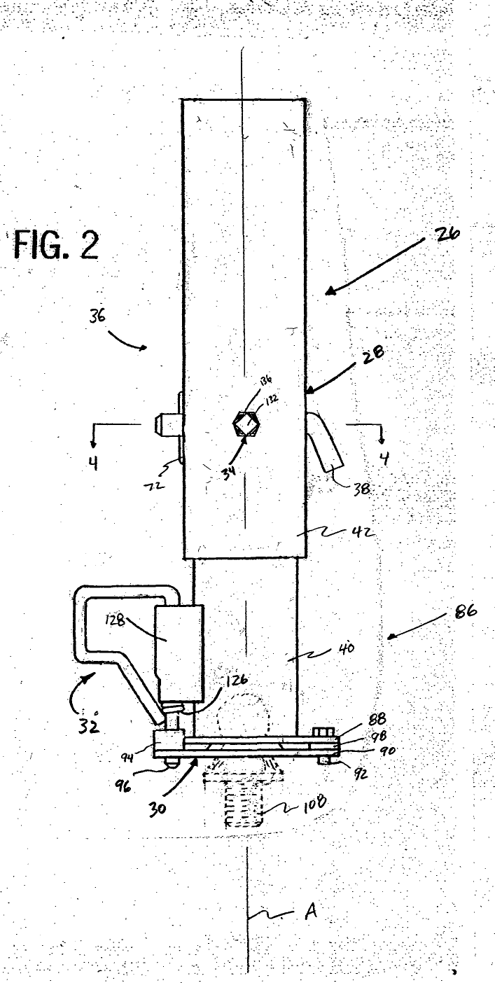

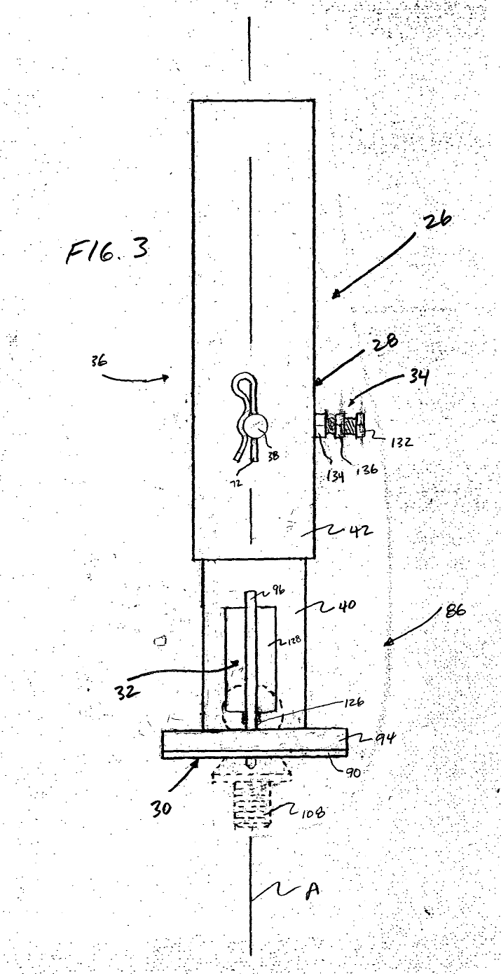

As illustrated in FIG. 2, coupling assembly 26 comprises height-adjustment device 28 and coupler mechanism 30. Optionally, coupling assembly 26 further comprises locking assembly 32 and friction fit assembly 34. In preferred embodiments, height-adjustment device 28 is disposed at an upper portion 36 of coupling assembly 26. FIG. 3 depicts coupling assembly 26 of FIG. 2 rotated ninety degrees about axis A. FIGS. 2 and 3, in combination, illustrate the various devices, mechanisms, and assemblies relative to each other in preferred embodiments.

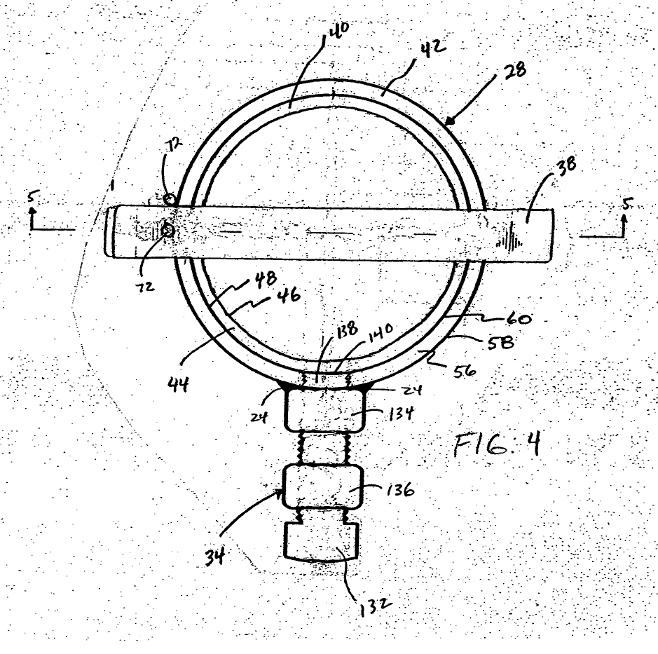

In FIG. 4, a top, cross-sectional view of coupling assembly 26, taken along line 4-4 of FIG. 2, details height-adjustment device 28 and friction fit assembly 34. As shown, height-adjustment device 28 comprises load-bearing pin 38, inner member 40, and outer member 42. Inner member 40 defines inner member periphery 44, inner member first surface 46, and inner member second surface 48.

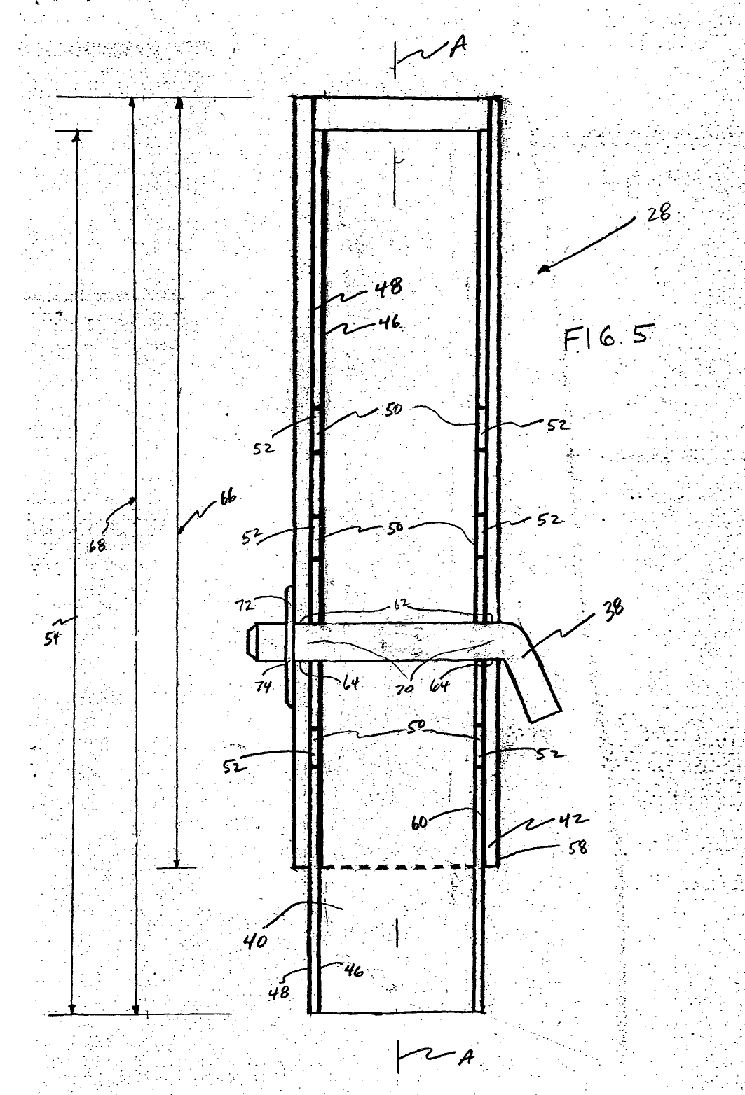

In FIG. 5, a side, cross-sectional view, taken along line 5-5 of FIG. 4, illustrates the interaction between inner member 40 and outer member 42. As shown, inner member 40 includes opposing inner member aperture pairs 50. Each aperture 52 within opposing inner member aperture pairs 50 extends from inner member first surface 46 to inner member second surface 48. Opposing inner member aperture pairs 50 are longitudinally spaced over all, or a portion, of inner member height 54 and circumferentially aligned about inner member periphery 44 (FIG. 4). While FIG. 5 illustrates five pairs 50 of apertures 52, the number of pairs employed can be varied to convenience.

Referring back to FIG. 4, outer member 42 extends around, and is in telescopic, sliding engagement with inner member 40. Outer member 42 defines outer member periphery 56, outer member first surface 58, and outer member second surface 60.

As shown in FIG. 5, outer member 42 includes opposing outer member aperture pair 62. Each aperture 64 within opposing outer member aperture pair 62 extends from outer member first surface 58 to outer member second surface 60. Opposing outer member aperture pair 62 is circumferentially-aligned about outer member periphery 56 to correspond to the circumferential alignment of opposing inner member aperture pairs 50 about inner member periphery 44. Outer member 42 defines outer member height 66.

The telescopic, sliding inner and outer members 40, 42 are co-axially aligned about axis A, as shown in FIGS. 4 and 5, such that the members exhibit a mating engagement. Peripheries 44, 56 (or corresponding cross-sections) of both inner member 40 and outer member 42 can comprise a multitude of shapes, for example, circular, square, rectangular, and the like. In one embodiment, inner member 40 and outer member 42 comprise hollow, elongate members (e.g., tubes). In a preferred embodiment, the elongate members are tubular.

When added together, inner member and outer member heights 54, 66 define device height 68 (FIG. 5). As members 40, 42 are telescopically, slidably manipulated with respect to each other, device height 68 can increase or decrease. As device height 68 changes, one of opposing inner member aperture pairs 50 can align with opposing outer member aperture pair 62 to form channel 70 through height-adjustment device 28 and, therefore, coupling assembly 26. Channel 70, when formed, is capable of receiving load-bearing pin 38.

To operate height-adjustment device 28, and therefore coupling assembly 26, a desired device height is determined. Thereafter, members 40, 42 are slidably adjusted relative to each other until the desired device height is achieved. Since inner member 40 comprises a plurality of opposing inner member aperture pairs 50 spaced along inner member height 54, channel 70 can be formed at (or very near) the desired device height. With channel 70 formed at or near the desired device height, load-bearing pin 38 is inserted into the channel. As a result, load-bearing pin 38 occupies one of opposing inner member aperture pairs 50 and occupies opposing outer member aperture pair 62. Should a new desired height be determined, load-bearing pin 38 can be removed, members 40, 42 re-adjusted, and the load-bearing pin re-inserted.

When occupying channel 70, load-bearing pin 38 can maintain the desired height of the coupling assembly 26 and can concurrently and/or simultaneously bear the vertical load (i.e., withstand the shear force) generated by the attached trailer, any trailer accessories, and any trailer contents.

In one embodiment, load-bearing pin 38 can maintain the desired height of the coupling assembly 26 and concurrently bear all, or substantially all, of the vertical load (i.e., withstand the shear force) of the attached trailer, trailer accessories, and trailer contents. As used herein, the term substantially all is defined as approximately ninety-five percent (95%) of the vertical load.

Thus, load-bearing pin 38 permits adjustablility of height-adjustment device 28, and therefore coupling assembly 26, while bearing the vertical load (i.e., withstanding the shear force) supplied by the attached trailer, any trailer accessories, and any trailer contents. These two functions are simultaneously and/or concurrently performed without relying on friction.

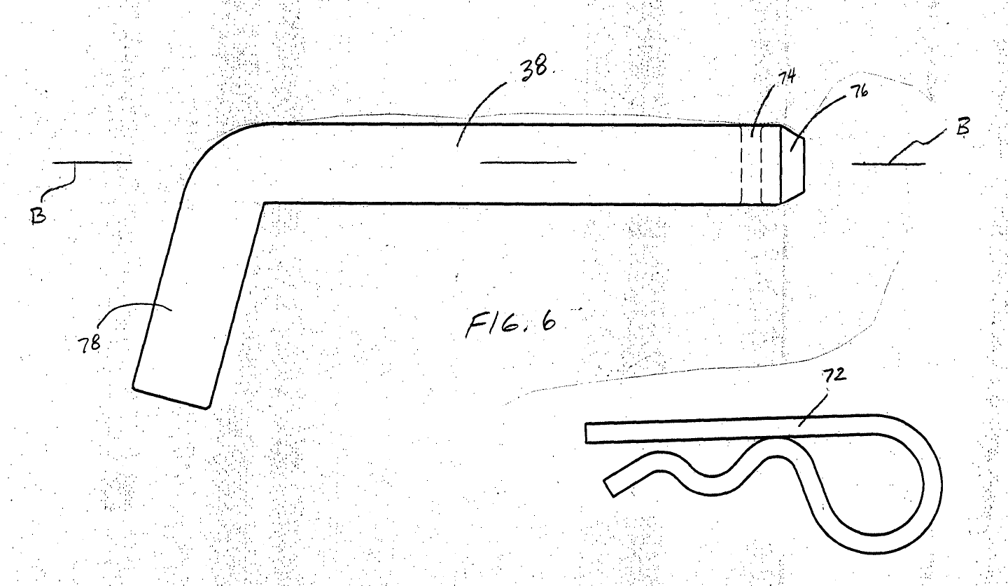

In a preferred embodiment, as shown in FIG. 6, load-bearing pin 38 comprises a solid, elongate member having load-bearing pin aperture 74 proximate a first load-bearing pin end 76. Load-bearing pin aperture 74 extends laterally, and entirely through, opposing sides of load-bearing pin 38. Load-bearing pin aperture 74 is designed and configured to receive a cotter pin 72, a hair pin, or other like securing device. As illustrated in FIG. 6, load-bearing pin 38 can be tapered at first load-bearing pin end 76 and angled proximate second load-bearing pin end 78. Load-bearing pin 38 can be constructed of steel, or other like material, and is designed to withstand at least about thirty-two thousand five hundred pounds (32,500 lbs.) of shear force applied transverse (i.e., perpendicular) to axis B. In preferred embodiments, load-bearing pin is capable of withstanding at least about thirty-nine thousand pounds (39,000 lbs.) of shear force applied transverse (i.e., perpendicular) to axis B. In more preferred embodiments, load-bearing pin is capable of withstanding at least about fifty thousand pounds (50,000 lbs.) of shear force applied transverse (i.e., perpendicular) to axis B.

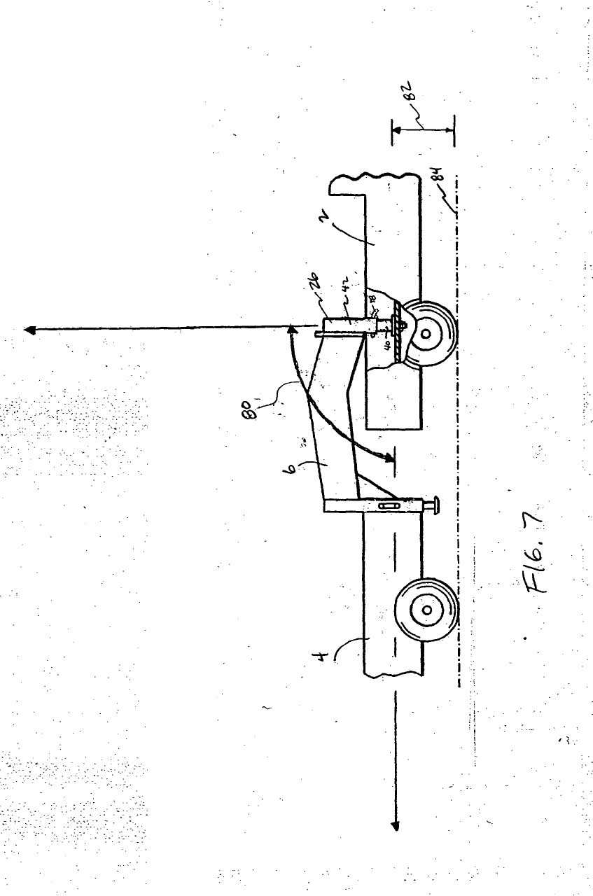

Referring to FIG. 7, adjustment of device height 68 (FIG. 5) permits angle 80, representing trailer pitch or level, to be customized. This can be highly desirable if bed height 82 above road surface 84 is not constant. For example, bed height 82 can vary with different towing vehicles 2, as trailer 4 endures variable loading conditions, and the like. In preferred embodiments, height-adjustment device 28, and therefore coupling assembly 26, is manipulated such that angle 80 comprises approximately ninety degrees. This permits trailer 4 to be approximately horizontal with respect to towing vehicle 2 and road surface 84.

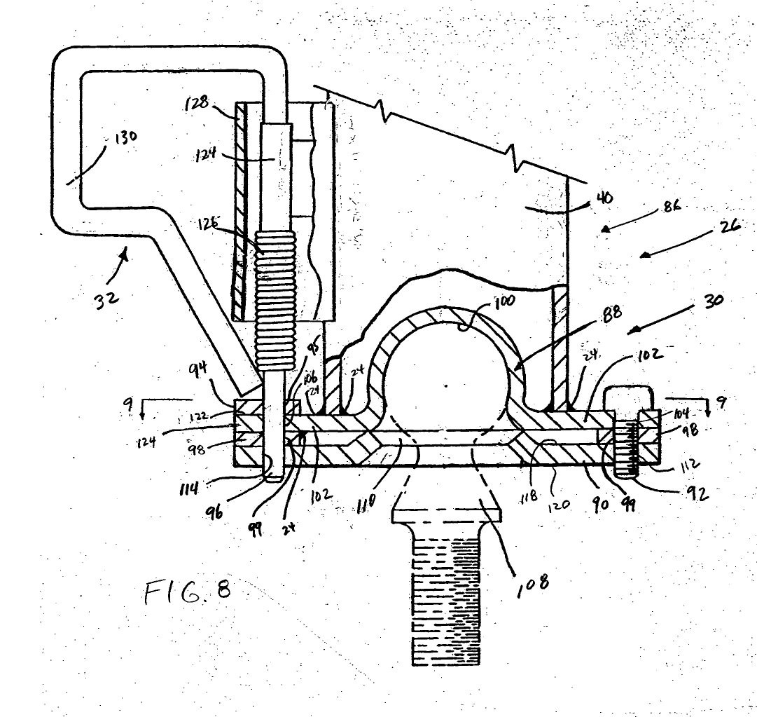

In FIG. 8, a lower portion 86 of coupling assembly 26 details coupler mechanism 30. Coupler mechanism 30 comprises stationary plate 88, lock plate 90, pivot pin 92, retainer bracket 94, lock pin 96, and spacers 98.

Stationary plate 88 comprises concave cavity 100, flange 102, first stationary plate aperture 104, and second stationary plate aperture 106. Stationary plate 88 can also comprise retainer bracket 94 secured to top stationary plate surface 122 proximate lock plate assembly end 124, typically by welds 24. Retainer bracket 94 comprises retaining plate aperture 95.

Concave cavity 100 extends upwardly into inner member 40 and is configured to receive mount 108 (e.g., a ball mount). Mount 108 can be secured within bed aperture 12 disposed in towing vehicle bed 10 of towing vehicle 2 (FIG. 1). Flange 102 provides a locale for inner member 40 to be secured to stationary plate 88, typically by welds 24. Resultantly, height-adjustment device 28 is secured to coupler mechanism 30, to form coupling assembly 26, and inner member 40 generally extends vertically, upwardly from stationary plate 88. Inner member 40 can be solid, or substantially solid, so long as mount 108 can still be received in concave cavity 100 of stationary plate 88.

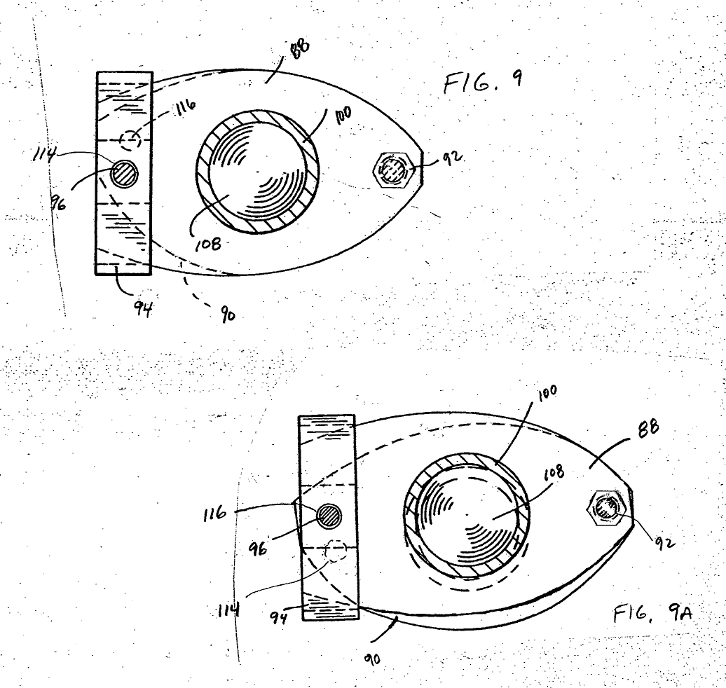

Referring to FIGS. 8, 9, and 9A, lock plate 90 comprises mount aperture 110, first lock plate aperture 112, a locked-open aperture 114, and a locked-closed aperture 116. Mount aperture 110 is configured to receive and selectively secure mount 108. As shown in FIG. 8, pivot pin 92 occupies first stationary plate aperture 104, one of spacer aperture 99, and first lock plate aperture 112.

Again referring to FIG. 8, lock pin 96 occupies retaining plate aperture 95, second stationary plate aperture 106, and another one of spacer aperture 99. Retaining plate aperture 95 functions to prevent lock pin 96 from losing alignment with second stationary plate aperture 106 disposed beneath locking assembly 32. Lock pin 96 next alternatively occupies either locked-open aperture 114 or locked-closed apertures 116, as highlighted in FIGS. 9 and 9A, to secure mount 108 within coupling assembly 26. FIG. 9 represents a top, cross-sectional view, taken along line 9-9, of the coupler mechanism 30 from FIG. 4. In FIG. 9, stationary plate 88 and lock plate 90 are aligned and therefore receive mount 108 within coupler mechanism 30. As shown, lock pin 96 is disposed within locked-open aperture 114. Thus, lock plate 90 is secured, with respect to stationary plate 88, in an open position.

With mount 108 received in coupler mechanism 30, lock pin 96 is slid upwardly and removed from locked-open aperture 114. Lock plate 90 can then be rotated about pivot pin 92, with respect to stationary plate 88, causing the lock plate and the stationary plate to become offset, as illustrated in FIG. 9A. When the two plates 88, 90 are offset, mount aperture 110 is effectively constricted. As shown in FIG. 9A, lock pin 96 is then released and inserted within locked-closed aperture 116. Thus, lock plate 90 is secured, with respect to stationary plate 88, in a locked position. In the locked position, mount 108 is retained within coupler mechanism 30 and, correspondingly, coupling assembly 26. To once again release mount 108 from coupler mechanism 30, the above-described method is repeated in reverse order.

Conventional coupler mechanisms, coupling assemblies, and methods of using the same, are detailed in U.S. Pat. Nos. 5,382,109 and 6,234,509, the disclosures of which are incorporated herein by this reference.

In FIGS. 3 and 8, a preferred embodiment of locking assembly 32 is shown. Locking assembly 32 comprises lock pin 96, guide 124, spring 126, and cover 128. In FIG. 8, locking assembly 32, with partially cut-away cover 128, is illustrated in detail. Guide 124 is attached to inner member 40, typically by one or more welds (not shown), thus securing locking assembly 32 to coupling assembly 26. As shown, locking pin 96 is slidably secured within guide 124 to permit vertical actuation of the locking pin. In preferred embodiments, locking pin 96 comprises a “D-shaped” handle 130, as illustrated in FIG. 8, to assist manual biasing of locking assembly 32. With lock plate 90 secured courtesy of locking assembly 32, coupling assembly 26, and therefore trailer 4, are prevented from undesirably disengaging from mount 108, and therefore towing vehicle 2.

In FIG. 4, a cross-section of friction fit assembly 34 is shown. Friction fit assembly 34 comprises adjustment bolt 132, fixed nut 134, and lock nut 136, each of which is threaded in preferred embodiments. Fixed nut 134 can be secured, typically by one or more welds 24, to outer member 42 proximate adjustment bolt aperture 138. Fixed nut 134 receives adjustment bolt 132 and, as the adjustment bolt is rotated, adjustment bolt end 140 travels through adjustment bolt aperture 138 in outer member 42 and is moved closer to, or farther away from, inner member 40 depending on the direction of rotation of the adjustment bolt. In a preferred embodiment, adjustment bolt 132 is rotated clockwise to bias adjustment bolt end 140 against inner member first surface 48. Once adjustment bolt end 140 is biased against inner member first surface 48, lock nut 136 can be rotated such that the lock nut is secured against fixed nut 134. Friction fit assembly 34 inhibits relative side-to-side movement between inner and outer members 40, 42. In other words, friction fit assembly encourages both inner and outer members 40, 42 to remain co-axially aligned about axis A. In preferred embodiments, friction fit assembly 34 does not carry a significant vertical load (i.e., withstand a significant shear force) supplied by trailer 4, trailer accessories, and trailer contents, even though the friction fit assembly may have the ability to do so.

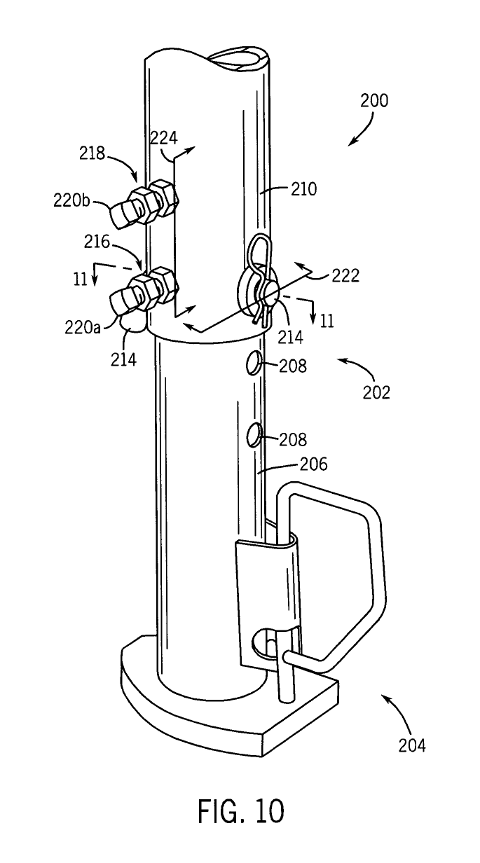

FIG. 10 illustrates a perspective view of another embodiment of a height-adjustable coupling assembly. A coupling assembly 200 is shown. Coupling assembly 200 includes a height-adjustment device 202 and a coupling mechanism 204. The height adjustment device 202 comprises: an inner member 206 comprising opposing inner member aperture pairs 208 (the apertures on the reverse side not shown). The device 202 further includes an outer member 210 comprising an opposing outer member aperture pair 212 (shown with pin 214) inserted therethrough). The outer member telescopically, slidably receives the inner member 206 such that the inner member can be height adjusted with respect to the outer member. A load-bearing pin 214 is selectively insertable through one of the opposing inner member aperture pairs 208 and the opposing outer member aperture pairs 212 and is used to both position the outer member with respect to the inner member and to bear substantially all of a vertical load exerted upon the coupling assembly. A first friction fit assembly 216 is in threaded engagement with the outer member 210 to maintain coaxial alignment between the inner member 206 and the outer member. A second friction fit assembly 218 is disposed above the first friction fit assembly 216 in threaded engagement with the outer member 210, the second friction fit assembly maintains coaxial alignment of the inner member and the outer member (particularly when the coupling assembly is use). Finally, the coupling assembly includes a coupler mechanism 204 secured to the height-adjustment device, the coupler mechanism engageable to a mount secured to a towing vehicle (see FIG. 1).

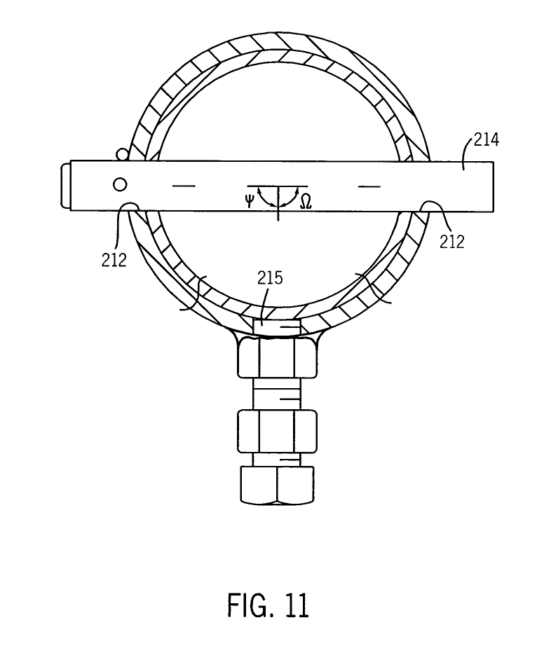

FIG. 11 illustrates a top, cross-sectional view, taken along lines 11-11 of FIG. 10 showing another embodiment of a height-adjustment device having a plurality of friction fit assemblies. Referring to FIGS. 10 and 11, the first and second friction fit assemblies inhibit relative side-to-side movement between the inner and outer members. The first and second friction fit assemblies promote coaxial alignment of the inner and outer members. The first friction fit assembly 216 includes a bolt 220a that passes through a first friction fit adjustment aperture (see FIG. 4) in the outer member 210, and the second friction fit assembly 218 includes a bolt 220b that passes through a second friction fit adjustment aperture in the outer member (FIG. 11). In one embodiment, the first and second friction fit adjustment apertures are substantially the same size. In one embodiment, the first and second friction fit adjustment apertures are vertically aligned along the outer member as shown. In one embodiment, the opposing outer member aperture pair defines a height adjustment plane 222 and the first and second friction fit adjustment apertures define a friction fit assembly plane 224, such that the height adjustment and friction fit assembly planes are perpendicular to each other. In one embodiment, the first and second friction fit assemblies do not carry a significant portion of the vertical load exerted upon the coupling assembly. In one embodiment, the first and second friction fit assemblies are not used to position a relative height of the outer member with respect to the inner member.

In one embodiment, the opposing outer member aperture pair 212 (with pin 214 therethrough) and one of the first and second friction fit assembly adjustment apertures 215 defines an arc angle Ψ or Ω of or about 90 degrees.

Despite any methods being outlined in a step-by-step sequence, the completion of acts or steps in a particular chronological order is not mandatory. Further, modification, rearrangement, combination, reordering, or the like, of acts or steps is contemplated and considered within the scope of the description and claims.

While the present invention has been described in terms of the preferred embodiment, it is recognized that equivalents, alternatives, and modifications, aside from those expressly stated, are possible and within the scope of the appending claims.

What is claimed is:

1. A coupling assembly for use with a trailer, the coupling assembly comprising:
a height-adjustment device comprising:
an inner member comprising opposing inner member aperture pairs;
an outer member comprising an opposing outer member aperture pair, the outer member telescopically, slidably receiving the inner member such that the inner member can be height adjusted with respect to the outer member; and
a load-bearing pin, the load-bearing pin selectively insertable through one of the opposing inner member aperture pairs and the opposing outer member aperture pairs, and is used to both position the outer member with respect to the inner member and to bear substantially all of a vertical load exerted upon the coupling assembly;
a first friction fit assembly in threaded engagement with the outer member to maintain coaxial alignment between the inner member and the outer member; and
a second friction fit assembly disposed above the first friction fit assembly in threaded engagement with the outer member, the second friction fit assembly to maintain coaxial alignment of the inner member and the outer member; and
a coupler mechanism secured to the height-adjustment device, the coupler mechanism engageable to a mount secured to a towing vehicle;

2. The coupling assembly of claim 1, wherein the first and second friction fit assemblies inhibit relative side-to-side movement between the inner and outer members.

3. The coupling assembly of claim 1, wherein the first and second friction fit assemblies promote coaxial alignment of the inner and outer members.

4. The coupling assembly of claim 1, wherein the first friction fit assembly includes a bolt that passes through a first friction fit adjustment aperture in the outer member, and the second friction fit assembly includes a bolt that passes through a second friction fit adjustment aperture in the outer member.

5. The coupling assembly of claim 4, wherein the first and second friction fit adjustment apertures are substantially the same size.

6. The coupling assembly of claim 4, wherein the first and second friction fit adjustment apertures are vertically aligned along the outer member.

7. The coupling assembly of claim 4, wherein the opposing outer member aperture pair defines a height adjustment plane and wherein the first and second friction fit adjustment apertures define a friction fit assembly plane, and wherein the height adjustment and friction fit assembly planes are perpendicular to each other.

8. The coupling assembly of claim 4 wherein one aperture of the opposing outer member aperture pair and one of the first and second friction fit assembly adjustment apertures defines an arc angle of about 90 degrees.

9. The coupling assembly of claim 1 wherein the first and second friction fit assemblies do not carry a significant portion of the vertical load exerted upon the coupling assembly.

10. The coupling assembly of claim 1, wherein the first and second friction fit assemblies are not used to position a relative height of the outer member with respect to the inner member.

11. A method of leveling a trailer, the method comprising:
providing a height adjustment device, an inner member comprising opposing inner member aperture pairs; an outer member comprising an opposing outer member aperture pair, the outer member telescopically, slidably receiving the inner member such that the inner member can be height adjusted with respect to the outer member; and a load-bearing pin, the load-bearing pin selectively insertable through one of the opposing inner member aperture pairs and the opposing outer member aperture pairs, and is used to both position the outer member with respect to the inner member and to bear substantially all of a vertical load exerted upon the coupling assembly;
a first friction fit assembly in threaded engagement with the outer member to maintain coaxial alignment between the inner member and the outer member; and a second friction fit assembly disposed above the first friction fit assembly in threaded engagement with the outer member, the second friction fit assembly to maintain coaxial alignment of the inner member and the outer member;
adjusting the inner member and the outer member relative to each other such that a desired height is achieved and a channel is formed proximate the desired height;
inserting the load-bearing pin within the channel formed by the adjusted members, the load-bearing pin bearing substantially all of a vertical load provided by the trailer such that the desired height is maintained and the trailer is leveled; and
frictionally fitting the inner member and the outer member with the first and the second friction fit assemblies.
